(19) United States
(12) Patent Application Publication
(10) Pub. No.: US 2014/0166373 A1
(43) Pub. Date: Jun. 19, 2014

(54) EXTENDABLE MOMENT WEIGHT TOOLS

(71) Applicant: GENERAL ELETRIC COMPANY, Schenectady, NY (US)

(72) Inventors: Jacob Andrew Salm, Simpsonville, SC (US); John David Ward, JR., Woodruff, SC (US)

(73) Assignee: General Electric Company, Schenectady, NY (US)

(21) Appl. No.: 13/719,803

(22) Filed: Dec. 19, 2012

(51) Int. Cl. G01G 21/23

(52) U.S. Cl. CPC G01G 21/23
USPC 177/126

(57) ABSTRACT

Extendable moment weight tools include an extendable base adapted to extend between at least a first distance and a second distance, wherein the extendable base supports a pair of weight scales at the first distance and the second distance, and, a first platform having an upper side provided with a pair of transverse component-supporting posts, and a lower side provided with a pair of transverse foot rails adapted to engage the respective pair of weight scales.

### BACKGROUND OF THE INVENTION

The subject matter disclosed herein relates to tools for determining the moment weight of components and, more specifically, to extendable moment weight tools for determining the moment weights of different sized components.

At least some known gas turbine engines include a core engine having, in serial flow arrangement, a fan assembly and a high pressure compressor which compress airflow entering the engine. A combustor ignites a fuel-air mixture which is then channeled through a turbine nozzle assembly towards low and high pressure turbines which each include a plurality of rotor blades that extract rotational energy from airflow exiting the combustor. Gas turbines are used in different operating environments to provide, for example, propulsion for aircraft and/or to produce power in land-based power generation systems.

During normal operation, gas turbine engines may experience high rotational speeds. An imbalance of the rotor may cause vibration of the rotor and induce stresses in the rotor bearings and support structures. Over time, continued operation with such stresses may lead to failure of the bearings, bearing support structure(s) and/or other rotor components. Failure of a component within the engine system may damage the system and/or other components within the system, and may require system operations be suspended while the failed component is replaced or repaired. More particularly, when the component is a turbofan gas turbine engine fan blade, a blade-out condition may also cause damage to one or more blades downstream from the released blade.

To facilitate minimizing imbalance of the disk or wheel during operation, the blades or buckets are assembled in a controlled manner. For example, one control that may be used in assembling buckets to rotors includes determining the moment weight of each bucket and using that information to map each bucket into specific wheel slots.

However, moment weight scales can often comprise large, heavy equipment that is logistically difficult and labor intensive to use on site at the location of the turbine. Moreover, moment weight scales are typically rigid structures that cannot account for multiple components having different sizes. Instead, multiple moment weight scales may be required, each of which are sized for different respective components.

Accordingly, alternative extendable moment weight tools would be welcome in the art.

### BRIEF DESCRIPTION OF THE INVENTION

In one embodiment, an extendable moment weight tool is disclosed. The extendable moment weight tool includes an extendable base adapted to extend between at least a first distance and a second distance, wherein the extendable base supports a pair of weight scales at the first distance and the second distance, and, a first platform having an upper side provided with a pair of transverse component-supporting posts, and a lower side provided with a pair of transverse foot rails adapted to engage the respective pair of weight scales.

In another embodiment, another extendable moment weight tool is disclosed. The extendable moment weight tool includes a base adapted to support a pair of weight scales separated by a distance, and, an extendable platform having an upper side provided with a pair of transverse component-supporting posts, and a lower side provided with a pair of transverse foot rails adapted to engage the respective pair of weight scales, wherein the extendable platform is adapted to extend between at least a first distance and a second distance such that the pair of transverse foot rails engage the pair of weight scales and the first distance and the second distance.

In yet another embodiment, another extendable moment weight tool is disclosed. The extendable moment weight tool includes an extendable base adapted to extend between at least a first distance and a second distance, wherein the extendable base supports a pair of weight scales at the first distance and the second distance, and, an extendable platform having an upper side provided with a pair of transverse component-supporting posts, and a lower side provided with a pair of transverse foot rails adapted to engage the respective pair of weight scales, wherein the extendable platform is adapted to extend between at least a first distance and a second distance such that the pair of transverse foot rails engage the pair of weight scales and the first distance and the second distance.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 illustrates an exemplary extendable moment weight tool with an extendable base according to one or more embodiments shown or described herein;

FIG. 2 illustrates the extendable moment weight tool of FIG. 1 with the extendable base in an extended position according to one or more embodiments shown or described herein;

FIG. 3 is a front view of platform according to one or more embodiments shown or described herein;

FIG. 4 is a bottom plan view of the platform of FIG. 3 according to one or more embodiments shown or described herein;

FIG. 5 is a top plan view of an extendable base according to one or more embodiments shown or described herein; and,

FIG. 6 is a top plan view of the extendable base of FIG. 5 in an extended position according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

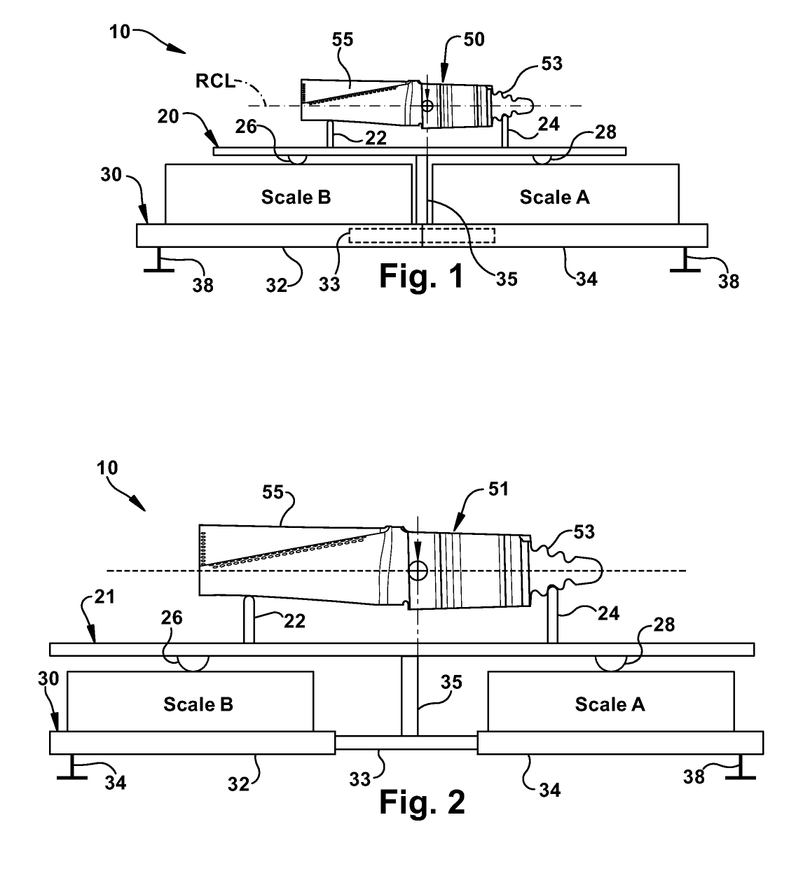

FIGS. 1 and 2 illustrate an exemplary but non-limiting embodiment of an extendable moment weight tool 10 that may be used to obtain the information necessary to calculate the moment-weight of components 50, 51, such as buckets used in multiple turbine stages of a particular turbine engine frame size. The extendable moment weight tool 10 includes a platform 20 and a base 30, at least one of which are extendable. The platform 20 generally comprises a pair of transverse component-supporting posts 22, 24 on its upper side and a pair of transverse foot rails 26, 28 on its lower side. The base 30 is adapted to support a pair of weight scales 40, 42 while the pair of transverse foot rails 26, 28 are engaged thereon.

Referring to FIGS. 1-4, the various exemplary embodiments of the platform 20 are illustrated, including a second platform 21 illustrated in FIG. 2 that is larger than the platform 20 illustrated in FIG. 1. Transverse component-supporting posts 22, 24 are provided on the upper side of the platform 20 in substantial vertical alignment with the foot rails 26, 28. For convenience, the post 24 will be referred to as the reference post and the post 22 will be referred to as the airfoil post. In a more generic sense, the posts 22 and 24 may be referred to as the radially inner and outer posts, respectively, as explained further herein.

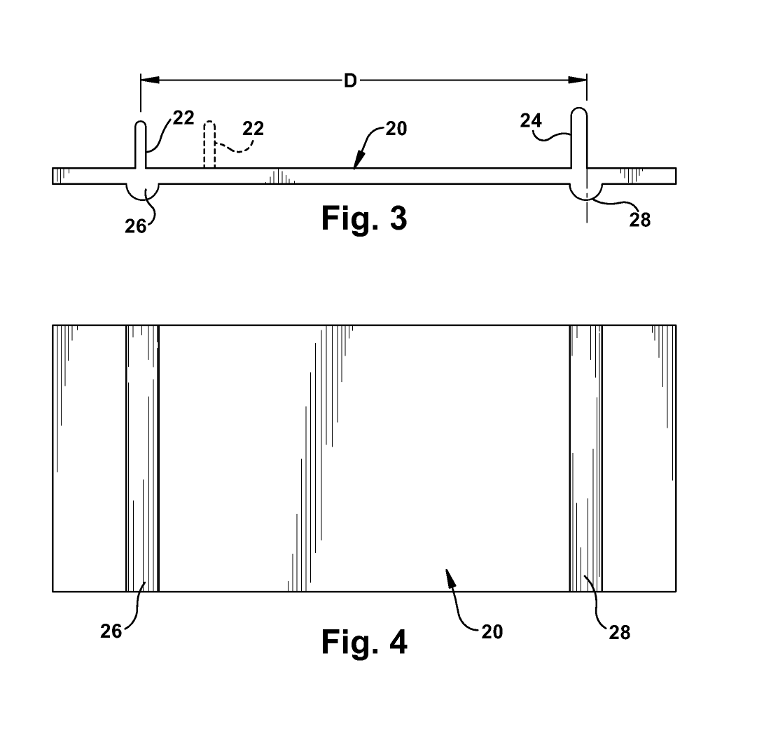

In some embodiments, such as that illustrated in FIG. 3, the centerline of the airfoil post 22 (illustrated as a dashed vertical line) may be coincident with the centerline of the foot rail 26. However, in some embodiments, such as that illustrated in FIGS. 1 and 2, the airfoil post 22 may be inside of the center line of the foot rail 26. In even some embodiments, the centerline of the airfoil post 22 may be outside of the centerline of the foot rail 26. Likewise, the reference post 24, may have its centerline in line with the foot rail 28, inside of the foot rail 28 or outside of the foot rail 28. While various configurations of different centerlines are presented herein, it should be appreciated that any combination may be implemented so that it can subsequently accounted for when determining the moment weight as should be appreciated herein.

In some embodiments, such as when the component is a bucket for a turbine, the reference post 24 may be specifically located so as to engage the so-called fir tree portion 52 (FIGS. 1 and 2) adjacent an arbitrarily chosen reference plane. In some embodiments, the location of the reference plane is determined by measurement from the bottom of a pair of pins located in fir tree grooves 53 (thus simulating a mating male projection of a complimentary fir tree groove in the turbine disk or wheel) to the centerline of the turbine rotor. In other words, the location of the reference plane can represent a known radial distance from the machine rotor centerline to a predetermined reference location on the bucket. In some embodiments, the reference plane is aligned with the outboard side of the reference post 24 and with the centerline of the foot rail 28. It will be understood, however, that the location of the reference plane relative to the post 24 may vary depending, for example, on which fir tree groove is engaged by the post 24. As a practical matter, the reference plane could extend along either side or through the center of the reference post 24.

In the exemplary embodiment illustrated in FIG. 1, the centerline of the airfoil post 22 is located a radial distance D from the reference plane A. “Radial” here is used in the context of a bucket as normally oriented relative to a turbine wheel, hence the characterization of airfoil post 22 as a radially outward post and reference post 24 as a radially inward post. In addition, the location of the airfoil post 22 relative to the reference post 24, and height of the airfoil post 22 are adjusted to have the radial centerline RCL of the component 50 (i.e., the bucket illustrated in FIG. 1) be substantially parallel to the platform 21. In addition, the Center of Gravity (COG) of the component 50 must be located between the airfoil post 22 and the reference post 24, and of course, the airfoil post 22 must be radially inward of the tip of the airfoil portion 55 of the component 50. In other words, the distance D must be long enough so that the COG is located between the airfoil post 22 and the reference post 24, but short enough that the airfoil post 22 lies within the airfoil portion 32 of the bucket 28.

For a platform 20 designed to accommodate a specific turbine frame size, the reference post 24 and the airfoil post 22 may remain at the same relative locations along the platform, but the height of the airfoil post 22 may require adjustment (by, for example, replacing the airfoil post) for buckets in different stages (within the same turbine frame size) to achieve the desired parallel orientation of the bucket RCL to the platform 12. In some embodiments, the platform 20 may further comprise one or more reference slots for receiving a first of the pair of transverse component-supporting posts 22. The plurality of reference slots may comprise different locations on the platform 20 to support components 50 of different sizes. For example, a first reference slot can be separated from a second transverse component-supporting post 24 by a first distance, and a second reference slot can be separated from the second transverse component-supporting post 24 by a second distance. The two different distances allow for the weighing of different sized components 50, 51 by selecting the appropriately spaced reference slot. Particularly, the first distance and the second distance may be selected to conform to different size components 50, 51. For example, reference slots may be positioned to handle components 50, 51 of between about 13 inches and about 30 inches (as may be required for components from a frame 9E or 9F General Electric® turbine), or between about 13 inches and about 25 inches (as may be required for components from a frame 7E or 7F General Electric® turbine), or between about 9 inches and about 17 inches (as may be required for components from a frame 6B or 6F General Electric® turbine), or even between about 9 inches to about 40 inches for other potential frames. While specific dimensions and ranges have been presented herein, it should be appreciated that these are exemplary only and any other dimensions and ranges may also be realized.

When the components comprise buckets or the like for turbines, such embodiments can provide a single platform 20 that can be utilized for different stage components (e.g., different stage buckets) from the same frame size. In some embodiments, such as those illustrated in FIGS. 1 and 2, even additional platforms 21 may be provided for other frame sizes such that a set of a few platforms can allow for the moment weight measurement of a plurality of components 50, 51 from different frame sizes.

As best illustrated in FIGS. 3 and 4, in one exemplary embodiment, the upper end or tip of the reference post 24 is machined or otherwise formed to have a radius of about 0.30 inch which then also defines the width of the post. The height of the reference post 24 to the start of the radius curve may be about 1.33 inches. The airfoil post 22 may have a tip radius and post width of about 0.25 inch, and a height to the start of the radius curve of about 1.02 inches. In some embodiments, the reference post 24 can be offset from the underlying foot rail 28 so that the reference plane that extends along one side of the reference post 24, passes through the center of the foot rail 28. In other embodiments, the reference post 24 can be offset from the underlying foot rail 28 so that the reference plane that extends along one side of the reference post 24, is inside of the center of the foot rail 28.

With continuing reference to FIGS. 1 and 2, in use the platform 20 is placed on the pair of identical weight scales 40, 42 each centered below respective foot rails 26, 28. The component 50 is supported on the airfoil post 22 and the reference post 24 as described above.

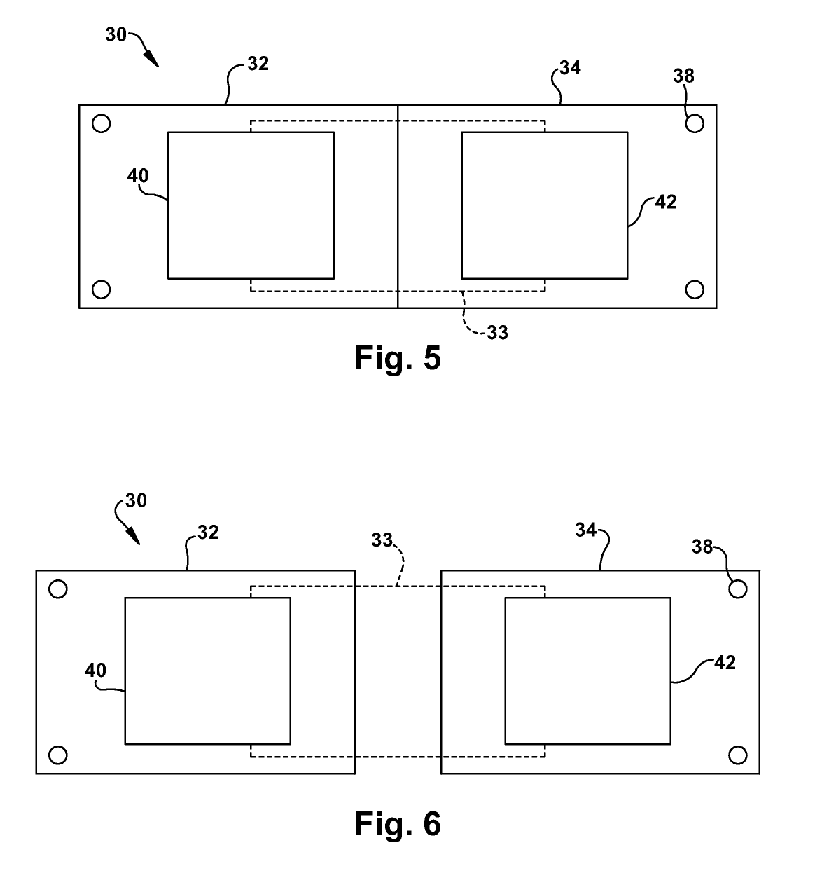

Referring to FIGS. 1-2 and 5-6, the extendable moment weight tool 10 further comprises an extendable base 30 adapted to support the pair of weight scales 40, 42. The extendable base 30 can comprise any supporting structure that can extend between multiple positions while still engaging and supporting the pair of weight scales 40, 42. Specifically, the extendable base can be adapted to extend between at least a first distance and a second distance, wherein the extendable base supports a pair of weight scales at the first distance and the second distance. For example, in some embodiments the extendable base 30 can comprise a first section 32 for supporting the first weight scale 40 and a second section 34 for supporting the second weight scale 42. The first section 32 and the second section 34 can be separable and be connected through any suitable extending devices such as a guide rail 33 as illustrated. The guide rail 33 can be connected to the underside of the extendable base 30, the topside of the extendable base 30, the front of the extendable base 30, the back of the extendable base 30, or be disposed internal the first section 32 and the second section 34 of the extendable base 30 (such as illustrated). In other embodiments, the extendable base 30 may comprise an accordion extension, a spring extension, or any other extension device suitable for extending the extendable base 30 while still supporting the pair of weight scales 40, 42.

In some embodiments, the extendable base 30 may have a recess or other defined areas to engage the pair of weight scales 40, 42 when they are being supported. Such embodiments can ensure the weight scales 40, 42 are in a suitable location with respect to the component 50 when determining the moment weight as should be appreciated herein.

In some embodiments, the extendable base 30 may comprise a reference post 35 that extends towards the platform 20 when being used to determine a moment weight. The reference post 20 can be received by a receiving slot in the platform 20 so that the extendable base 30 and the platform 20 are engaged in a predefined alignment. Such embodiments may help ensure the proper configuration of the overall extendable moment weight tool 10 when measuring the moment weight of one or more components 50.

Still referring to FIGS. 1 and 2, in even some embodiments, the extendable base 30 may comprise a plurality of height-adjustable feet 38. The plurality of height-adjustable feet 38 can be connected to the underside of the extendable base 30 to support the extendable moment weight tool off of the ground, shelf or other surface on which it rests. Furthermore, each of the plurality of height-adjustable feet 38 are vertically adjustable so that the overall extendable moment weight tool 10 can be leveled through the selective vertical adjustments of specific height-adjustable feet 38.

The extendable base 30 can thereby provide a single extendable base 30 that can be used to determine the moment weight of a plurality of components 50 that have different lengths and require the pair of weight scales 40, 42 to be separated by different distances. In some embodiments, the extendable moment weight tool 10 may comprise a plurality of platforms 20, 21, each sized differently to collectively accommodate a plurality of sized components 50, 1 such as a set of components 50 used for a particular frame size of a turbine. For example, a first platform may be utilized for determining the moment weight of components 50 for a frame 7F or 7E frame General Electric® turbine. Such a frame can comprise a plurality of reference slots so that it can determine the moment weight of components 50 from different stages, such as stage 1 buckets and stage 2 buckets. A second platform 21 may be utilized for determining the moment weight of components 51 for a different frame, such as a frame 9F or 9E frame General Electric® turbine. Such a frame can also comprise a plurality of reference slots so that it can determine the moment weight of components 51 from different stages, such as stage 1 buckets and stage 2 buckets. Even a third platform may be utilized for determining the moment weight of components for yet a different frame, such as a frame 6B or 6F frame General Electric® turbine. Such a frame can also comprise a plurality of reference slots so that it can determine the moment weight of components from different stages, such as stage 1 buckets and stage 2 buckets. The extendable base 30 may then be able to extend between three different lengths to support the pair of weight scales 40, 42 at the different distances required by the distance between the pair of transverse foot rails 28, 28 for each respective platform 20.

In some embodiments, the platform 20 may comprise an extendable platform such that it can expand between multiple distances. The extendable platform can utilize a guide rail (similar to the guide rail 33 discussed above with reference to the extendable base 30) or any other suitable device that allows the extendable platform 20 to extend between at least two different positions. The extendable platform 20 can then support a first component 50 of a first length when in a first position, or support a second component 50 of a second length when in a second, extended position. For example, the extendable platform can be adapted to extend between at least a first distance and a second distance such that the pair of transverse foot rails engage the pair of weight scales and the first distance and the second distance. Such extendable platforms 20 can be utilized in conjunction with an extendable base 30 (such as that disclosed in FIGS. 1-2 and 5-6), or utilized in conjunction with one or more fixed bases to comprise the extendable moment weight tool 10.

The extendable moment weight tool 10 can thereby be utilized to determine the moment weight of one or more components 50 using the various configurations disclosed herein. For example, given the set-up illustrated in FIG. 3, the moment weight MW of the component 50 (illustrated as a bucket) can be determined by MW=W_{T} (X+R) where W_{T} is the total weight recorded by the pair of weight scales 40, 42, X is is the distance from the fir tree machining datum to the bucket's center of gravity (COG) and R is the radial distance from the first tree machining datum to the center line of the rotor. The COG be determined using X=((W₄₀*D)/W_{T})−C, where W₄₀ is the weight from the first scale 40 supporting the airfoil portion 55, D is the total distance between the pair of transverse foot rails 26, 28 and C is the distance between the second transverse component-supporting post 24 and the second foot rail 28. It should be appreciated that the specific values will depend, for example, on the relative location of the pair of transverse component-supporting posts 22, 24 with respect to their respective transverse foot rails 26, 28.

It should now be appreciated that the extendable moment weight tool can be utilized to determine the moment weight of a plurality of components having different sizes. The extendable moment weight tool can comprise an extendable base and/or an extendable platform to provide a plurality of supporting configurations for different sized components requiring weight scales separated by different distances. Such embodiments can reduce the amount of equipment, labor and inconsistencies otherwise present when determining the moment weight for different components having different sizes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An extendable moment weight tool comprising:
an extendable base adapted to extend between at least a first distance and a second distance, wherein the extendable base supports a pair of weight scales at the first distance and the second distance; and,
a first platform having an upper side provided with a pair of transverse component-supporting posts, and a lower side provided with a pair of transverse foot rails adapted to engage the respective pair of weight scales.

2. The extendable moment weight tool of claim 1, wherein a first centerline of one of said pair of transverse component-supporting posts is coincident with or inside of a first centerline of one of said pair of transverse foot rails, and a second centerline of the other of said pair of transverse component-supporting posts is coincident with or inside of a second centerline of the other of said pair of transverse foot rails.

3. The extendable moment weight tool of claim 1 further comprising a second platform larger than the first platform, wherein the second platform has a second upper side provided with a second pair of transverse component-supporting posts, and a lower side provided with a second pair of transverse foot rails adapted to engage the respective pair of weight scales in place of the first platform when the extendable base is in an extended position.

4. The extendable moment weight tool of claim 3, wherein the second pair of transverse component-supporting posts are separated by a longer distance than the pair of transverse component-supporting posts of the first platform.

5. The extendable moment weight tool of claim 1, wherein the upper side of the first platform comprises a plurality of reference slots for receiving a first of the pair of transverse component-supporting posts.

6. The extendable moment weight tool of claim 5, wherein a first reference slot of the plurality of reference slots is separated from a second of the pair of transverse component-supporting posts by a first distance, and a second reference slot of the plurality of reference slots is separated from the second of the pair of transverse component-supporting posts by a second distance.

7. The extendable moment weight tool of claim 6, wherein the first distance and the second distance are selected to conform to different size components.

8. The extendable moment weight tool of claim 1, wherein the extendable base comprises a plurality of height-adjustable feet.

9. The extendable moment weight tool of claim 1, wherein the extendable base comprises a first section that supports a first of the pair of weight scales and a second section that supports a second of the pair of weight scales, wherein the first section and the second section are separable and connected by a guide rail.

10. The extendable moment weight tool of claim 1, wherein a first of the pair of transverse component-supporting posts has a height lower than a second of the pair of transverse component-supporting posts.

11. The extendable moment weight tool of claim 1, wherein the extendable base further comprises a vertical reference post, and wherein the first platform comprises a receiving slot that can receive the reference post to maintain alignment.

12. An extendable moment weight tool comprising:
a base adapted to support a pair of weight scales separated by a distance; and,
an extendable platform having an upper side provided with a pair of transverse component-supporting posts, and a lower side provided with a pair of transverse foot rails adapted to engage the respective pair of weight scales, wherein the extendable platform is adapted to extend between at least a first distance and a second distance such that the pair of transverse foot rails engage the pair of weight scales and the first distance and the second distance.

13. The extendable moment weight tool of claim 12, wherein a first centerline of one of said pair of transverse component-supporting posts is coincident with or inside of a first centerline of one of said pair of transverse foot rails, and a second centerline of the other of said pair of transverse component-supporting posts is coincident with or inside of a second centerline of the other of said pair of transverse foot rails.

14. The extendable moment weight tool of claim 12 further comprising a second base longer than the first base, wherein the second base is adapted to support the pair of weight scales separated by a longer distance in place of the first base when the extendable platform is in an extended position.

15. The extendable moment weight tool of claim 12, wherein a first of the pair of transverse component-supporting posts has a height lower than a second of the pair of transverse component-supporting posts.

16. The extendable moment weight tool of claim 12, wherein the base further comprises a vertical reference post, and wherein the extendable platform comprises a receiving slot that can receive the reference post to maintain alignment.

17. An extendable moment weight tool comprising:
an extendable base adapted to extend between at least a first distance and a second distance, wherein the extendable base supports a pair of weight scales at the first distance and the second distance and,
an extendable platform having an upper side provided with a pair of transverse component-supporting posts, and a lower side provided with a pair of transverse foot rails adapted to engage the respective pair of weight scales, wherein the extendable platform is adapted to extend between at least a first distance and a second distance such that the pair of transverse foot rails engage the pair of weight scales and the first distance and the second distance.

18. The extendable moment weight tool of claim 17, wherein a first centerline of one of said pair of transverse component-supporting posts is coincident with or inside of a first centerline of one of said pair of transverse foot rails, and a second centerline of the other of said pair of transverse component-supporting posts is coincident with or inside of a second centerline of the other of said pair of transverse foot rails.

19. The extendable moment weight tool of claim 17, wherein a first of the pair of transverse component-supporting posts has a height lower than a second of the pair of transverse component-supporting posts.

20. The extendable moment weight tool of claim 17, wherein the extendable base further comprises a vertical reference post, and wherein the extendable platform comprises a receiving slot that can receive the reference post to maintain alignment.
